(19) United States
(12) Patent Application Publication
(10) Pub. No.: US 2005/0125401 A1
(43) Pub. Date: Jun. 9, 2005

(54) Wizard for usage in real-time aggregation and scoring in an information handling system

(75) Inventors: Steven R. Carr, San Jose, CA (US); Venkatakrishnan Muthuswamy, Cupertino, CA (US); Tudor Har, Santa Clara, CA (US); Philip R. Bosinoff, Ashland, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L. P., Houston, TX (US)

(21) Appl. No.: 10/728,686

(22) Filed: Dec. 5, 2003

(51) Int. Cl. G06F 17/30

(52) U.S. Cl. 707/5

(57) ABSTRACT

An information handling method includes constructing aggregates for a case set, computing aggregates from detailed in-memory data that is dynamically cached, and iteratively mining data during an entity transaction to define new aggregates and refine existing aggregates based on entity responses. The aggregates are defined and refined using a wizard.

### CROSS-REFERENCE

The present application is related to the subject matter disclosed in the co-pending United States patent application entitled “REAL-TIME AGGREGATION AND SCORING IN AN INFORMATION HANDLING SYSTEM”, docket number 200313119-1, naming Steven R. Carr, Venkatakrishnan Muthuswany, Tudor Har, and Philip R. Bosinoff and filed on even day herewith.

### BACKGROUND OF THE INVENTION

Data mining tools are used to identify behavioral propensities of entities in a population, for example to predict product success in a particular locality, to determine whether a specific customer is likely to respond favorably to an offer, or to alert an official to the possibility of engagement in fraudulent activity. Data mining tools base predictions on a common set of attributes obtained for each entity in a sample. Many attributes are aggregated statistics generated from past behavior of the entity.

The data mine is populated with a case set extracted and transformed from an operational data store. The case set commonly contains one row per entity. One column of the case set, called the goal attribute, represents an outcome to be predicted. Other columns of the case set are predictor attributes derived from various tables in the data store. Many of predictor attributes are aggregated from multiple distinct events, both historical and current. The case set is built from a random sample of entities, for example customers, for whom the outcome of prediction is known previously.

Before building the case set, data is profiled, an action that helps to identify potential predictor attributes. The data is sampled and transformed to build a case set. Some of the potential predictor attributes are generated by aggregates and extracted from the production data to produce an output, a single relation configured as one row per entity and a fixed number of columns, which is inserted into the data mine.

After loading of the case set into the data mine, data mining tools such as Enterprise Miner™ from SAS Institute of Cary, N.C., are used to build prediction models for each behavior to be identified or predicted.

Models are applied back to the production environment by scoring each of the customers in the production database. The same aggregates used in the previous mining operation are generated for the individual entities during the scoring process. A score, or probability, is produced from each model. The purpose of data mining is fulfilled when the scores are used to influence an interaction with the entity.

In traditional applications of data mining, the aggregates are regenerated and scored for each entity as part of a batch process. Scores are recorded in the production database. The scores are not used, however, until the next interaction with the entity, for example when a customer phones or visits a store or web site, a time when the scores may not reflect significant recent behavior.

### SUMMARY

In accordance with an embodiment of the disclosed system, an information handling method includes constructing aggregates for a case set, computing aggregates from detailed in-memory data that is dynamically cached, and iteratively mining data during an entity transaction to define new aggregates and refine existing aggregates based on entity responses. The aggregates are defined and refined using a wizard.

### BRIEF DESCRIPTION OF THE DRAWINGS

Embodiments of the invention relating to both structure and method of operation, may best be understood by referring to the following description and accompanying drawings.

FIG. 1 is a schematic block diagram illustrating an embodiment of an information handling system that can be used for Zero Latency Enterprise (ZLE) applications and data mining.

FIG. 2 is a schematic block diagram showing an embodiment of a recommender with an offer manager for usage with a scoring engine and aggregation engine.

FIG. 3 is a schematic block diagram depicting an embodiment of a recommender that includes a rules engine in combination with the scoring engine and aggregation engine.

FIG. 4 is a schematic block diagram that illustrates an embodiment of a recommender including a recommender server capable of reading scoring models, aggregate definitions from database tables, and metadata.

FIG. 5 is a flow chart showing an embodiment of an information handling method that can be used in a data mining application.

FIG. 6 is a flow chart depicting an embodiment of an information handling method that can be used in a system with a data mining capability.

FIG. 7 is a flow chart showing another embodiment of an information handling method.

FIG. 8 is a flow chart illustrating an embodiment of a method of creating simple aggregates using a simple aggregate wizard.

FIGS. 9A through 9F are pictorial views showing display screens that can be generated in an example of an entry session using an embodiment of a simple aggregate wizard.

FIGS. 10A, 10B, 10C, and 10D are schematic Universal Modeling Language (UML) diagrams that illustrate an embodiment of Aggregate and AbstractAggregateFactory class representations.

FIGS. 11A through 11C are pictorial views showing display screens that can be generated in an example of an entry session and showing conversion methods.

FIG. 12 is a flow chart illustrating an embodiment of an information handling method for generating aggregate objects.

FIGS. 13A and 13B are pictorial views show display screens that can be generated in an example of an entry session in an Aggregation Wizard embodiment enabling construction of custom functions.

### DETAILED DESCRIPTION

Traditional data mining tools utilize batch data, which is by nature out of date. To use data mining effectively in a real-time environment, scoring of entities should be made in real-time, using aggregates computed in real time, and make recommendations based upon the real-time scores. What is also desired is a capability to modify scoring models and rules as more is discovered about the entities.

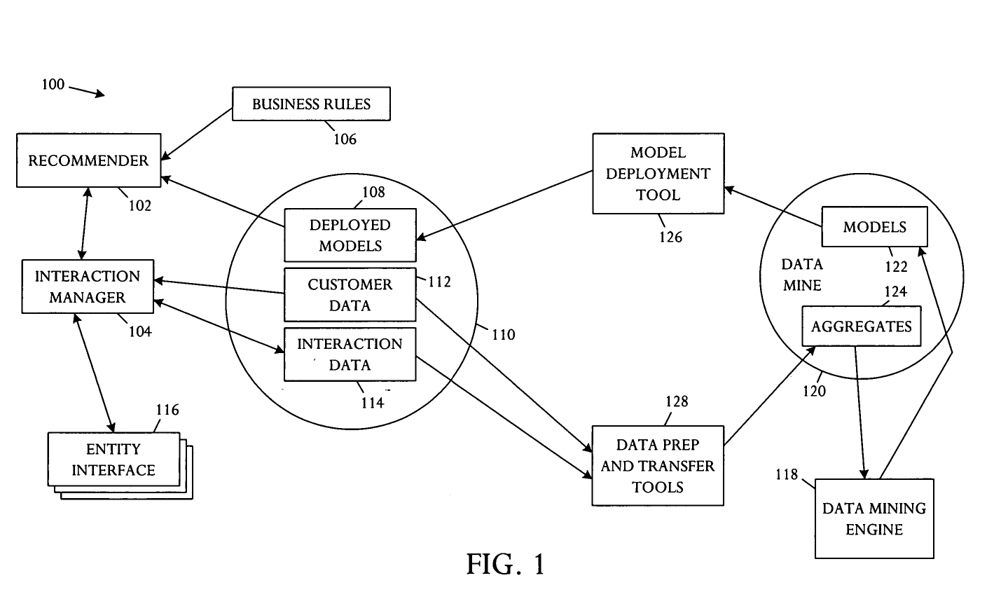

Referring to FIG. 1, a schematic block diagram illustrates an embodiment of an information handling system 100 that can be used for Zero Latency Enterprise (ZLE) applications and data mining. The ZLE framework is supported by Hewlett Packard Company of Palo Alto, Calif. The information handling system 100 includes a recommender 102. The recommender 102 is a functional computation engine configured to enable real-time aggregation and real-time scoring. In an illustrative embodiment, the recommender is a black-box application framework for deploying custom systems that perform real-time scoring and implementation of business rules. Typical uses of the Recommender are to make personalized offers and to advise of attempts to commit fraud.

The recommender 102 comprises an aggregation engine capable of computing aggregates in real-time from in-memory data that is dynamically cached during a session with an entity.

The information handling system 100 includes an interaction manager 104, a component that efficiently caches detailed entity data during interactive sessions, forwards the information to the recommender to personalize the session, and make offers. The entity data is supplied during interactive sessions via one or more entity interfaces 116. In a common application, the entities can be customers who supply information relating to commercial transactions and inquiries. In various applications, the entities can be any sort of entity including persons, corporations, organizations, government agencies, and the like. In an illustrative embodiment, the recommender 102 and interaction manager 104 are supplied by Hewlett Packard Company of Palo Alto, Calif. Hewlett Packard Company also has a ZLE Development Kit, familiarly known as the ZDK, used by HP professional services and partners to build custom ZLE applications that run on a NonStop Server platform 110. The NonStop Server platform serves as an information base that stores, for example, deployed models 108, customer data 112, and interaction data 114.

Among the application templates in the ZDK, two are highly useful in the real-time application of data mining. The recommender 102 hosts business rules 106 that are implemented in a rules engine and makes the offers. The business rules 106 may utilize scores obtained from mining models 108. A specific example uses a Blaze Advisor rules engine, which can supply offers based on business rules that are written and tested in Blaze Advisor Builder. Blaze Advisor can be licensed from Fair Isaac Corporation of San Rafael, Calif. Blaze Advisor is incorporated into the recommender by adding appropriate Java™ Archive (JAR) format files obtained from Fair Isaac to the recommender class path.

The recommender 102 returns offers based upon information supplied by an interaction manager 104. The illustrative recommender 102 has multiple component engines that derive offers from the input data. The engines work in various combinations and use business rules 106 and/or data mining models 108 to derive the offers.

The scoring engine scores information using data mining models built using a data mining engine 118 and aggregates 124 in the data mine 120 creating models 122 in the data mine 120. One suitable data mining engine 118 is SAS Enterprise Miner™. Models generated by SAS Enterprise Miner are deployed to the NonStop SQL database using Genus Deployment Tool 126 from Genus Software, Inc. of Cupertino, Calif. The scores can be used within the Blaze Advisor business rules, as one criterion for making an offer. Usage of data mining models within business rules is not mandatory. Data is prepared on the NonStop Platform 110 using data preparation tools 128 and moved from the NonStop Platform 110 to the data mine 120 using the transfer tools 128. Data can be deployed from the data mine 120 to the NonStop Platform 110 using a model deployment tool 126.

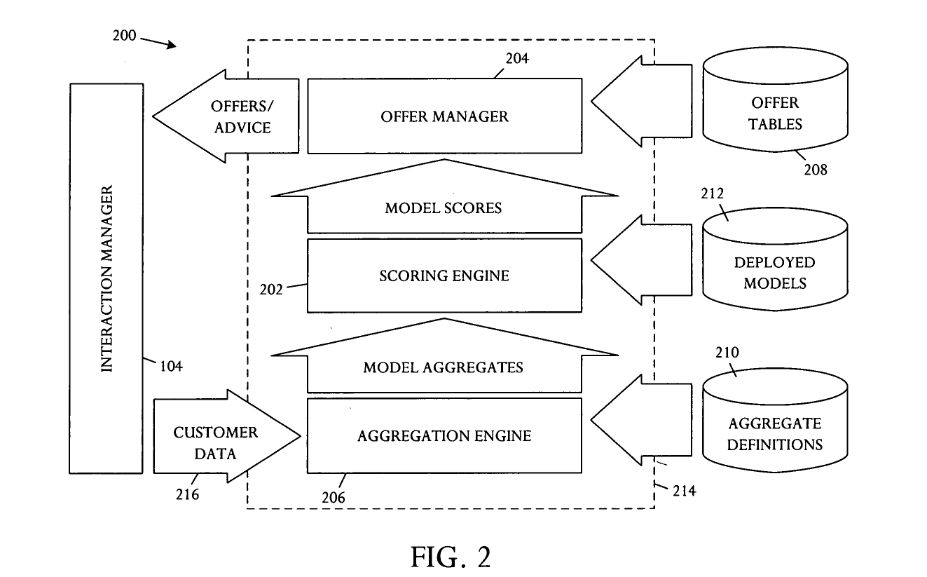

Referring to FIG. 2, a schematic block diagram illustrates an embodiment of a recommender 200 that can be used in an information handling system. The recommender 200 comprises a scoring engine 202 capable of scoring information using at least one data mining model that derives scores from aggregated data, an offer manager 204 capable of mapping scores to offers based on entered configuration information, and an aggregation engine 206. The aggregation engine 206 computes user-defined aggregates dynamically for real-time scoring by the scoring engine 202.

The aggregation engine 206 utilizes aggregates that have been redefined without recoding. The aggregation engine 206 can compute simple aggregates and compute compound aggregates from one or more component aggregates according to specifications that are flexibly defined using an aggregation wizard interface. In some embodiments or applications, the wizard operates as a user interface that exposes entity data through a user-written Interface Device Language (IDL), the IDL defining a context object containing the input data including record-sets, singular records, and scalar elements.

In the illustrative embodiment, the scoring engine 202, offer manager 204, and aggregation engine 206 operate in combination as a recommender server 214. Various engines in the recommender 200 personalize transactions by applying information such as business rules, offer tables 208, aggregate definitions 210, and prediction models 212 against cached data from the entity 216.

The recommender 200 can operate within an iterative process that tracks correlations discovered in data mining, applies a prediction model to the correlations to determine results, aggregates the results, and data mines the results to identify new aggregates and refine existing aggregates.

In some embodiments, the recommender 200 can also include the offer manager 204. The offer manager 204 uses criteria entered into a table to select offers based upon scores from various mining models. The offer manager 204 selects a best offer or offers from a specified group of offers, according to a predetermined criteria. Each offer within the group is associated with a particular mining model that predicts the likelihood of the customer accepting that offer. Attributes of an offer specification used to select the offer include thresholds, values, costs, and the like. Using the three threshold, value, and cost attributes, selection criteria can be specified based on raw score, weighted score or net profit.

The offer manager 204 maps scores to offers, based on information entered into a table 208 using the recommender GUI configuration tool. The offer manager 204 enables a user to build a recommender 200 that makes use of the scoring engine 202 without using a rules engine such as Blaze Advisor. All that is lost is a capability to write ad-hoc business rules.

The offer manager 204 is highly useful to a user desiring to deploy a recommender server that uses data mining models without Blaze Advisor. Alternatively, the offer manager 204 can also be invoked from business rules to simplify the business rules. In place of rules to assess the score of each relevant model, the rules can simply decide which offer group is applicable and have the offer manager select the offer or offers with the highest weighted score.

Referring again to FIG. 1 in combination with FIG. 2, mining models 122 derive scores from aggregated data 124, not the detailed data that is supplied by the interaction manager 104. The aggregates are highly specific to an application. The identification of useful aggregates for data mining is an iterative process.

The recommender 200 includes the aggregation engine 206 to dynamically generate current aggregates on the fly from the detailed data provided to the recommender 200. The scoring engine 202 operates in combination with the aggregation engine 206. Business rules can, but need not, also make use of aggregates computed by the aggregation engine 206.

A user defines the aggregates operated upon by the mining models or business rules using a recommender Graphical User Interface (GUI) configuration tool.

In some embodiments, a real-time information handling apparatus comprises the interaction manager 104 and the recommender 200. The interaction manager 104 populates a recommender context with data cached for an entity transaction session. The recommender 200 receives the recommender context and further comprises at least one recommender driver and/or utility, a custom recommender server that is configured via the at least one recommender driver and/or utility dynamically loading a stub, and the aggregation engine 206. The aggregation engine 206 is defined using a graphical user interface wizard that reflects upon Java classes generated from the graphical user interface to identify available records and attributes. The scoring engine 202 is capable of computing scores for at least one predefined business model and to make offers contingent on resulting scores.

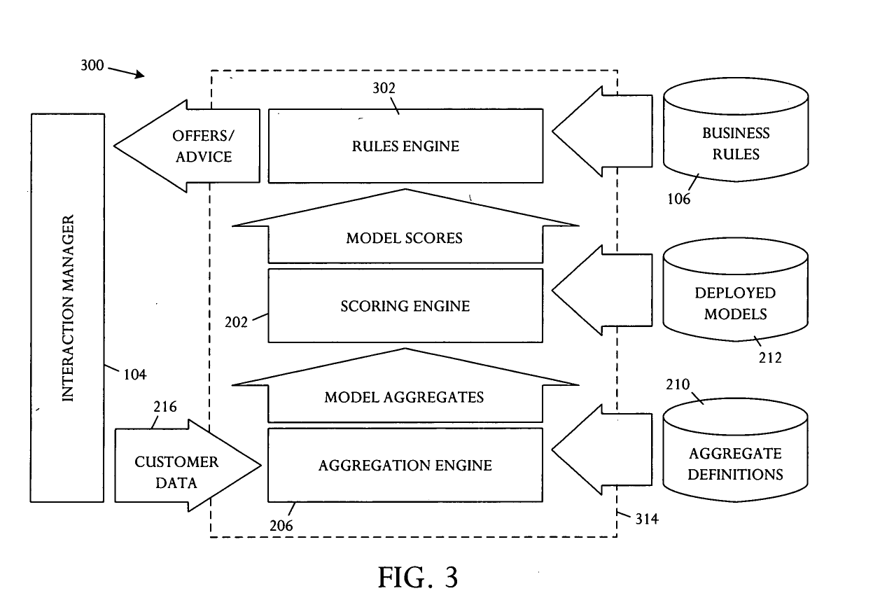

Referring to FIG. 3, a schematic block diagram depicts an embodiment of a recommender 300 that includes a rules engine 302 in combination with the scoring engine 202 and aggregation engine 206 to form the recommender server 314. The rules engine 302 accesses and operates on business rules and methods to perform analysis on the basis of a single parameter, a structure defined in the Interface Definition Language (IDL), referenced herein as the Recommender context. The Recommender context structure contains several sequences of other structures. The structure sequences represent a distinct record-set that contains records for the designated entity, drawn from a specified table or view. Fields in each structure represent columns of the record-set. During an entity or customer interaction, the interaction manager 104 populates the recommender context with the data that the interaction manager has efficiently cached for the duration of the session, and passes the context to the recommender.

The recommender 300 may typically be used with business rules 106 and/or mining models 210. In either case, a user can deploy or implement the recommender 300 by supplying only a minimal amount of custom program code. Alternatively, a recommender 300 can be configured that uses neither business rules nor mining models in an implementation that almost certainly would use a significant amount of custom program code.

In an example of a zero latency data mining application, the recommender 300 has a capability to compute scores upon demand during a live customer interaction, based on all of the customer's activity up to the current moment. The computation is performed on detailed customer data collected in a central Zero Latency Enterprise (ZLE) data store. The aggregates used by the mining models 210 are extracted from the detailed data during the customer interaction and are passed through the scoring engine 202 that derives the score for each applicable mining model.

Referring again to FIG. 1 in combination with FIG. 3, to score the data in the production environment, the model deployment tool 126 exports the mining models from the data mining tool 118 to the system 110 that holds the operational data. In one embodiment, SAS Enterprise Miner exports the mining models in the form of executable Java™ byte code, called JScore. The byte code is deployed into the ZLE Data Store, and later loaded and executed directly by the recommender 102, 300.

The data mining industry has developed a standard for representation of mining models called PMML (Predictive Model Markup Language). The recommender 102, 300 also incorporates a scoring engine 202 that evaluates decision trees expressed in PMML.

In an illustrative embodiment, the recommender 102, 300 operates in conjunction with a product suite, named the Genus Mining Integrator for NonStop SQL from Genus Software, Inc. of Cupertino, Calif., to support data mining in the ZLE architecture. The product suite complements a MicroStrategy desktop and interoperates between SQL/MX on the NonStop Server and SAS Enterprise Miner on the HP-UX operating system from Hewlett Packard. The product suite fully exploits the parallel architecture of the NonStop Server and specialized optimizations of SQL/MX for data mining. The Data Preparation Tool 128 performs the profiling step and data transformation steps on the NonStop Server. The Data Transfer Tool 128 transfers the data from the NonStop Server to Enterprise Miner. After the prediction models are developed in Enterprise Miner, the Model Deployment Tool 126 deploys the completed models back to the NonStop Server.

Referring again to FIG. 3, the aggregation engine 206 is part of the recommender 300 and operates to construct the aggregates during an entity interaction from the detailed data supplied by the interaction manager 104. The aggregation engine 206 operates on aggregates defined for real-time operation and implements the real-time computation.

Business analysis techniques conventionally have not been applied in real time. However, the recommender 300 disclosed herein can be coupled with a data mining integrator and the interaction manager 104 to complete the toolset enabling application of business intelligence in real-time.

In an illustrative embodiment, a system includes technical innovations enabling business intelligence application in real-time thereby supplying capabilities useful in a Zero Latency Enterprise (ZLE). Aggregation can be performed in real-time to support real-time scoring. The aggregates can be defined for usage in a system with real-time aggregation and scoring capabilities using an aggregation wizard. The illustrative recommender 300 is configured to support real-time scoring and application of business rules 106.

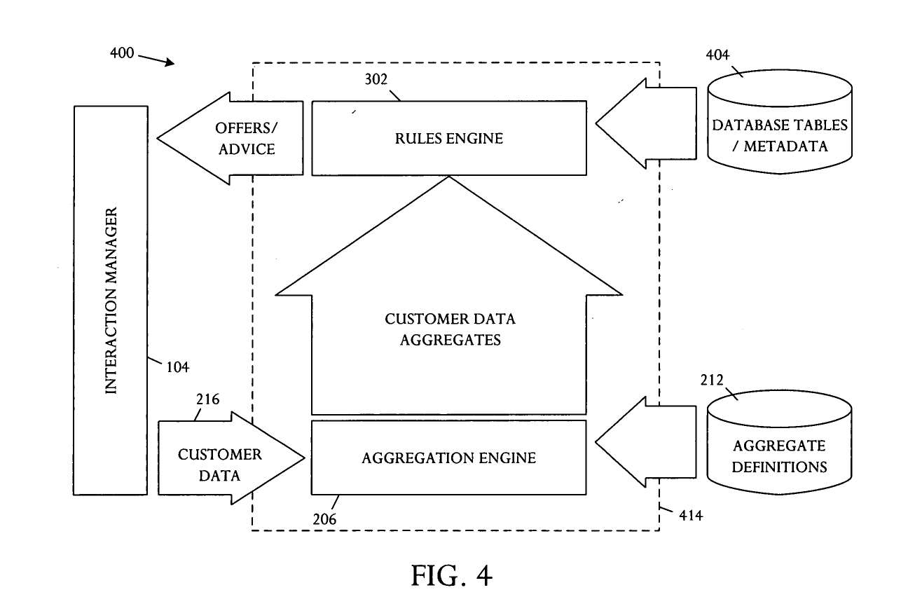

Referring to FIG. 4, a schematic block diagram depicts an embodiment of a recommender 400 comprising a recommender server 414 that is capable of reading scoring models, aggregate definitions from database tables, and metadata 404. The recommender 400 also comprises a rules engine 302 and an aggregation engine 206 that accesses information read by the recommender server 402 and uses reflection to construct aggregate objects incorporating fields, static methods, and aggregate functions so that the aggregate objects are ready to compute as requests arrive.

Within the recommender server 402, business rules acting through the a business rules engine, the interaction manager, and the aggregation engine 206, can invoke a scoring engine to compute scores for specific business models, in specific circumstances, and make offers contingent on the resulting scores. The scoring engine can directly invoke the aggregation engine to compute relevant aggregates. In a particular embodiment, the scoring function and offer selection can be performed directly by a business rules engine, for example engine 302 shown in FIG. 3.

Referring to FIG. 5, a flow chart illustrates an embodiment of an information handling method 500 that can be used in a data mining application. The information handling method 500 comprises generating a case set from operational store data 502. The data includes a goal attribute that reflects an outcome to predict and a plurality of predictor attributes aggregated from entity past behavior. The method 500 further comprises building a prediction model 504, computing attribute aggregates in real-time 506, and scoring entities in real-time based on the prediction model 508. A score is the probability of a particular modeled outcome and is derived from the same predictor attributes, including the real-time aggregates, which are used to define the case set.

The prediction model is iteratively modified between interactions with various entities to form a learning cycle. Similarly, business rules are iteratively modified, also in real-time, during acquisition of entity information between entity interactions based on model scores.

As an entity transaction takes place, the transactions can be tracked in real-time and aggregates generated in real-time based on the tracked transactions.

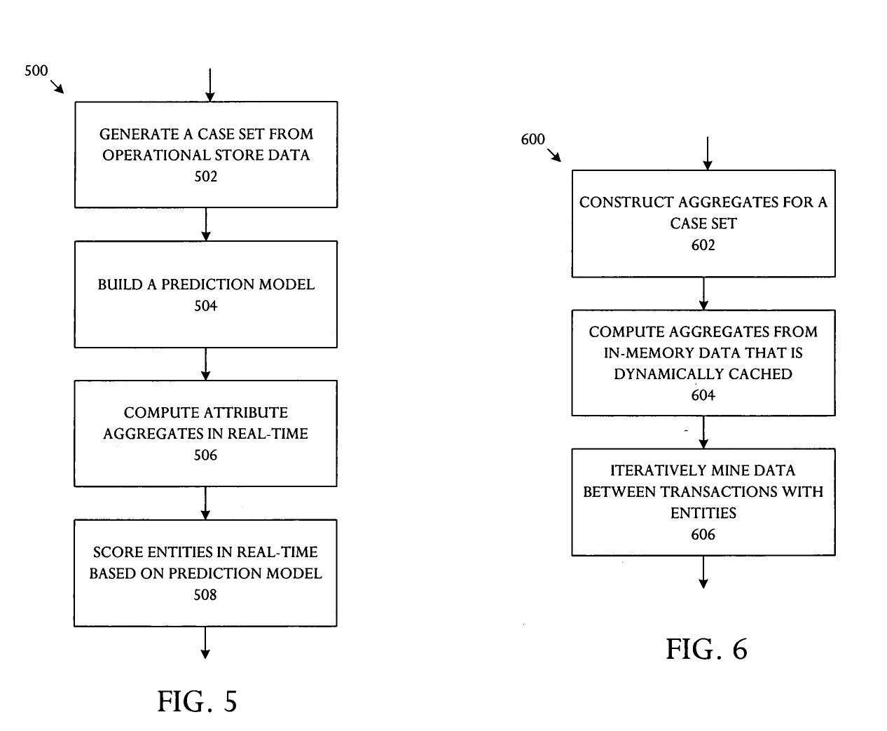

Referring to FIG. 6, a flow chart depicts an embodiment of an information handling method 600 that can be used in a system with a data mining capability. The information handling method 600 comprises constructing aggregates for a case set 602 and computing aggregates from detailed in-memory data that is dynamically cached 604. Data is iteratively mined 606 during many transactions with multiple entities, for example customer transactions, to define new aggregates and refine existing aggregates based on entity responses. The aggregates are defined and refined autonomously, without recoding, upon definition of new aggregates. Aggregation can be performed for real-time scoring with aggregates drawn from different tables in a memory containing entity-related data.

In an illustrative embodiment, most aggregates for the case set can be constructed initially, prior to interactive updating during an entity session, using SQL statements. However, the same SQL statements are generally unsuitable for adaptation to perform aggregation for real-time scoring for several reasons. Transformations used to build case sets can rarely be performed in a single SQL statement. Various aggregates are drawn from different tables containing entity-related, for example customer-related, data. For inclusion of more than one table in the join that contains multiple records per customer, the number of rows to be counted, summed or averaged in the aggregate can be distorted using a single SQL statement. For example, the SQL statement or statements to perform the aggregations can be highly complex and time-consuming, in fact so time-consuming that calculations cannot typically be finished on a per-interaction basis as needed for real-time scoring. Furthermore, each aggregate typically has different criteria for selecting the rows to be included in the aggregate. Finally, compound aggregates, such as ratios, are computed from other aggregates.

A particular version of SQL, NonStop SQL/MX™ from Hewlett Packard Corporation of Palo Alto, Calif., has useful extensions to SQL syntax that enable efficient case set construction. Individual queries scan relevant rows of various related tables for selected entities in the case set, an operation that is generally too computation-intensive for efficient construction of a case set of one entity for each online interaction. In some implementations real-time scoring may exploit some SQL/MX capabilities. Generally, SQL/MX supplies some support for performing aggregates but is not sufficiently fast to perform the operations in real-time. In the particular implementations, aggregates that do not require up-to-the-second real-time values for scoring can be generated by SQL/MX as pre-computed or “historical” attributes. In a more efficient technique, the illustrative aggregation engine 206 shown in FIGS. 2, 3, and 4 computes aggregates from detailed in-memory data that the Interaction Manager already caches for other purposes.

Data Mining is an iterative learning process. Each application of a data mining model during an entity transaction or session can potentially result in new data collection based on the entity response. Newly collected interaction data can be mined again and models refined. One consequence of the learning process is identification of better predictor attributes—new aggregates are defined and existing aggregates refined. The aggregation engine facilitates frequent changes to aggregate definitions.

In some embodiments and/or in some conditions, the recommender aggregation engine incorporates real-time scoring in which aggregate definitions are modified using changes in custom coding, for example additions or modifications to Java™ code. The illustrative aggregation engine supplements the custom-coding capabilities using a technique that enables definition of new aggregates autonomously, without recoding of the aggregation engine.

In some embodiments, the interaction manager and recommender can be Common Object Request Broker Architecture (CORBA®) applications with interfaces customized to specific business environments. The recommender interface defines record-sets that are passed to the recommender through the customized business method.

Referring to FIG. 7, a flow chart depicts another embodiment of an information handling method 700. The information handling method 700 comprises compiling a customized interface definition language (IDL) file to generate stubs and skeletons 702. A distinct class is generated for each structure or record-set 704 including each record-set as an array of objects. Aggregates are defined 706 using a wizard that reflects upon classes generated from an interface to identify available records and attributes. A skeleton is dynamically loaded 708 to create a custom server. A recommender context is populated with data cached for an entity transaction session 710. Aggregates are computed in real-time 712 from data cached in memory.

In an illustrative embodiment, the customized IDL is compiled to generate stubs and skeletons in both C++ and Java™ and to generate a distinct class for each structure or record-set. The distinct class contains fields enumerated in the IDL. The class representing the context is also generated, including each record-set as an array of objects. The C++ stub is statically bound into the customized interaction manager. The recommender dynamically loads the Java skeleton to become a custom server. Recommender drivers and utilities dynamically load the Java stub to drive or configure the custom recommender server.

A user employs Graphical User Interface (GUI) wizards to define aggregates for the aggregation engine. The wizards reflect upon the Java classes generated from the interface to identify the available records and attributes.

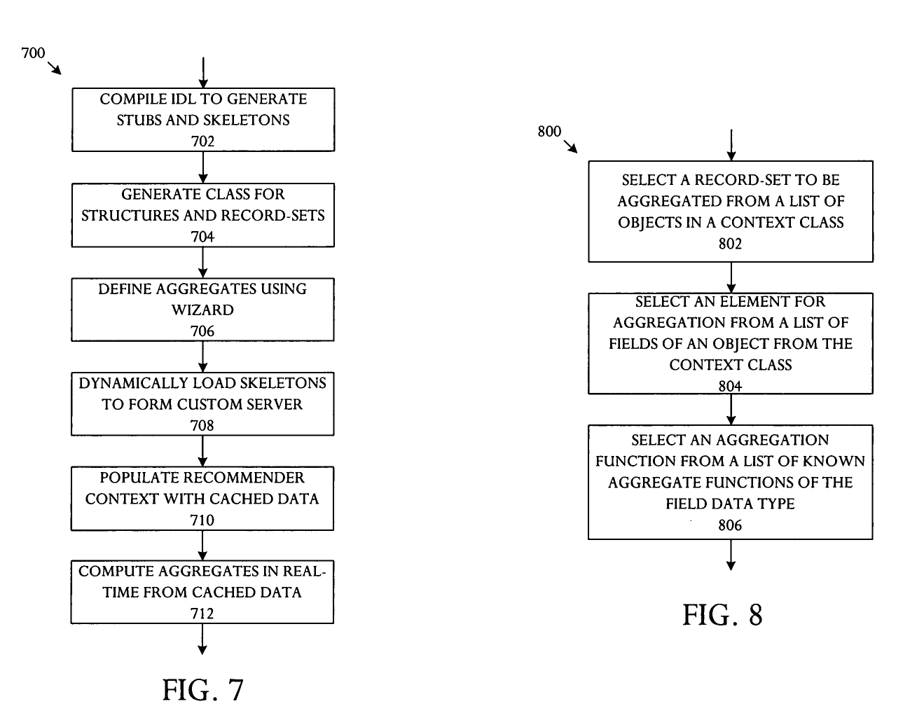

Referring to FIG. 8, a flow chart illustrates an embodiment of a method of creating simple aggregates 800 using a simple aggregate wizard. The method comprises selecting a record-set to be aggregated from a list populated with all objects in a context class 802, selecting an element for aggregation from a list populated with fields of an object of the context class objects 804, and selecting an aggregation function from a list populated with known aggregate functions applicable to a data-type of a field of the object fields 806.

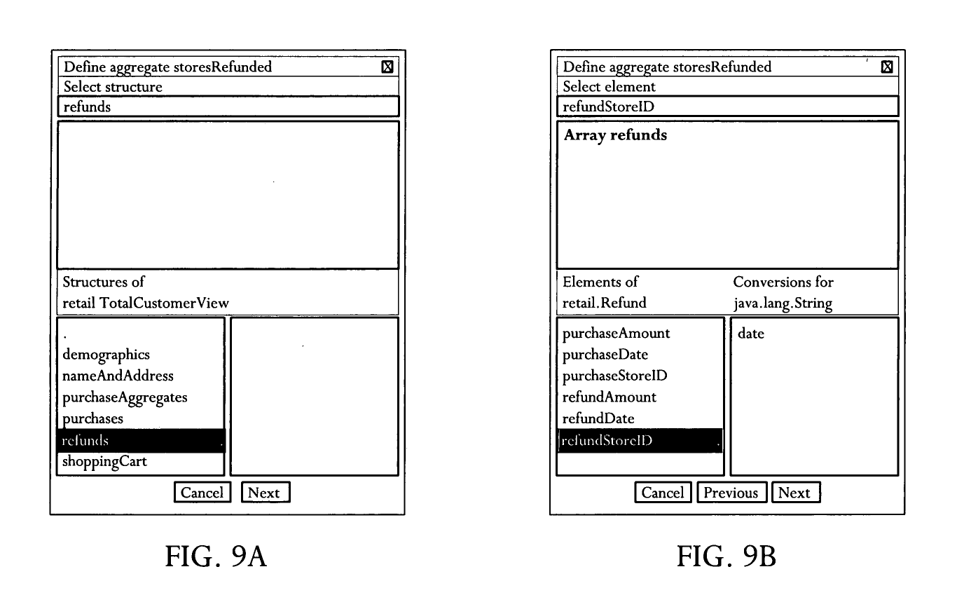

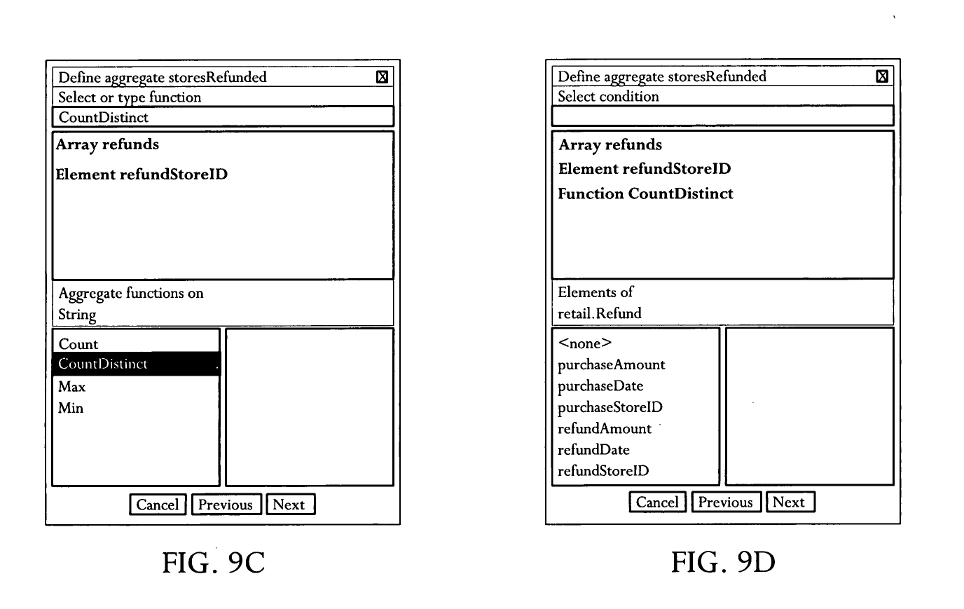

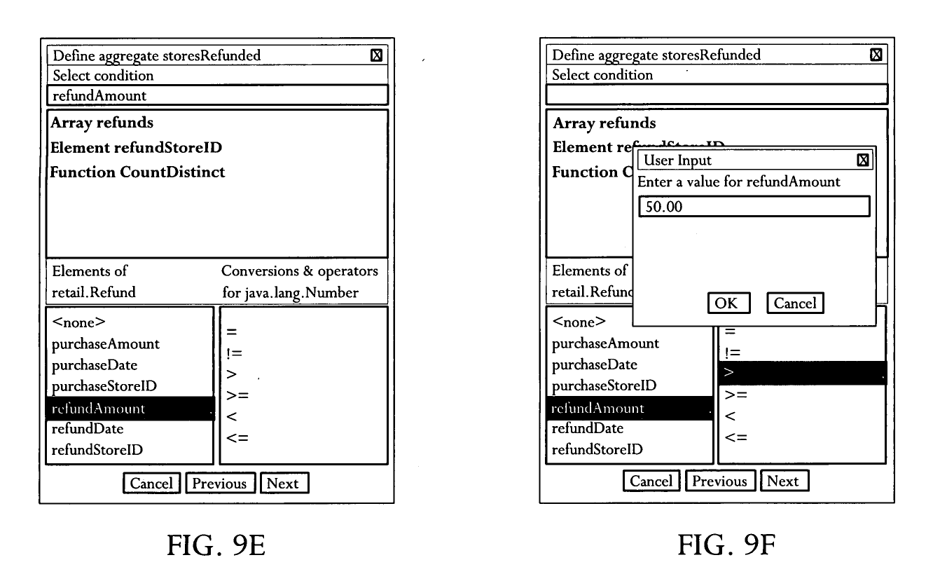

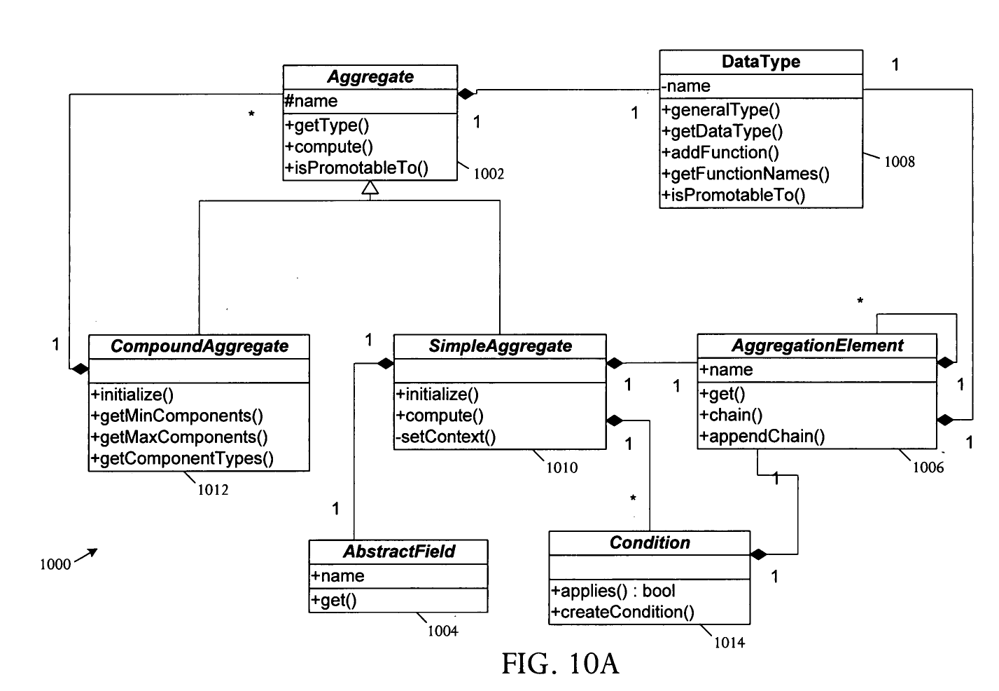

Referring to FIGS. 9A through 9F, multiple pictorial views show display screens that can be generated in an example of an entry session using an embodiment of a simple aggregate wizard. The recommender implements a model for aggregate definition that enables a user to easily define the aggregates. The user employs a simple aggregate wizard to create simple aggregates with each step of the wizard presenting a list box from which the user selects an item.

In an illustrative embodiment, the first step of the wizard involves selection of a record-set to be aggregated using a display screen such as the screen shown in FIG. 9A. The record-set is picked from a list populated with all the objects in the context class. The user selects one of the displayed record collections to aggregate upon.

In a second step, shown in FIG. 9B, the user selects an element to be aggregated from a list populated with all fields of the object selected in the previous step.

In a third step, depicted in FIG. 9C, the user selects an aggregation function from a list populated with all known aggregate functions applicable to the data-type of the field picked in the immediately previous step. The recommender can include aggregate functions such as count, sum, min, max, mean, count-distinct, and, or, first and last. Sum and mean are used for numeric types. And and or are used for Boolean data types.

In a fourth step, illustrated in FIG. 9D, the user applies conditions by selecting zero, one or more conditions for the aggregate. The user begins specifying a condition by selecting an element as in the second step. Selection of a Boolean element is sufficient to specify the condition. For other elements, for example numeric or string elements, selection alone is generally insufficient to define the condition so that the user further specifies the condition by selecting a relational operator from a second list box. Selection of the second list box triggers display of a further entry box into which the user specifies a literal numeric or string value against which the element is compared. The user designates Finish when all conditions are specified. All rows are included in the computation of the aggregate if no conditions are specified.

For some aggregates, further information is to be supplied. Using the screen depicted in FIG. 9E, the user can select the element on which a condition is based. Conversions and operators are displayed. The user can select an operator, as shown in FIG. 9F, and is prompted to enter a comparison value.

The context definition context can include a struct, rather than an array of structs, to designate a unique record, such as the customer record, or a record containing pre-computed historical aggregates. When the user picks customer in the first page of the wizard, the Finish button is presented on the second page when the user picks an element. When the user selects an element belonging to a unique object, specification of an aggregate function of conditions is unnecessary.

Frequently, the element to be aggregated is a derived attribute rather than a physical column of the record. For example, the user may wish to aggregate on margin, a derived attribute computed from unitCost and unitPrice columns. The user can write a simple one-line method in Java™ that computes the margin from other fields of the object. Once written, the method is exposed to the wizard through reflection, enabling the executing method to examine or “introspect” upon itself, and added to the list of elements that can be picked in the second and fourth steps of the wizard.

One way to implement the margin function is to write a getMargin method in the product class, which has unit-cost and unit-price fields. However, the product class can be a final class generated from the interface definition by the IDL compiler. The product class cannot implement a method, since the interface definition language (IDL) does not define implementation. Instead the user can write a static method, called margin, which takes a reference to a product as the sole parameter. All static methods supplied by the customer that take a product as the parameter are listed, along with the fields of product, when the user selects a product or a collection of products in the first step of the wizard.

In some embodiments, a user may enter a formula for a derived attribute such as margin directly into the wizard. However, entry of syntactically- and semantically-correct formulas into the wizard can be very challenging. Graphical expression builders are hard to use. A much more simple operation is selection of a method with a descriptive name from a list. Once implemented, a method such as the margin method can be used repeatedly in various aggregates on margin for different product classes.

In some embodiments, the recommender is not intended to completely eliminate writing of custom Java™ code for a specific business model, but rather to eliminate the need to rewrite the Java™ code every time the user refines data mining models. Once the useful set of methods are written for the data model of a particular business, aggregates can be easily and quickly added, discarded and modified.

Many aggregates are conditioned by recent behavior. Typical examples include a sum of purchases during the last 7 days, a count of store visits in the last 3 days, a count of distinct stores visited in the past month, and the like. To facilitate expression of such types of conditions, recent behavior can be computed from a date stored in the record of the event, relative to today's date. One implementation difficulty is that no date type is defined in CORBA. Dates are passed as strings. What is desired is a technique for indicating that a field contains a date.

The recommender implements a relational static method called date that receives and parses a string parameter and returns an object of the Java Date class. When the user selects a field of the string type in the fourth step of the wizard, date is listed as a choice in the second list box, along with the various relational operators. By picking date in the second list box, the user indicates that the string field purchaseDate is to be parsed as a date. The second list box responds by displaying the fields and get-methods of the Date class. The user can then pick day, month or year, among other choices, from the second list box to extract the corresponding element of the purchase date. Furthermore, the recommender can implement another static method, called days, that takes a Date parameter and returns the number of days relative to today, expressed as negative for a past date, and positive for a future date. Past and future dates can be included in the choices in the second list box when the attribute type is Date. The date static method is an example of a relational element static method in which an element is identified on the basis of a relationship with a defined element. The days static method is an example of a relative static method which returns the relative difference in the comparison of two relational elements.

To specify the condition “purchased in the last 7 days”, the user can pick purchaseDate from the first list box, date from the second list box, then days, the greater-than (>) symbol, and finally enter −7 into the edit box.

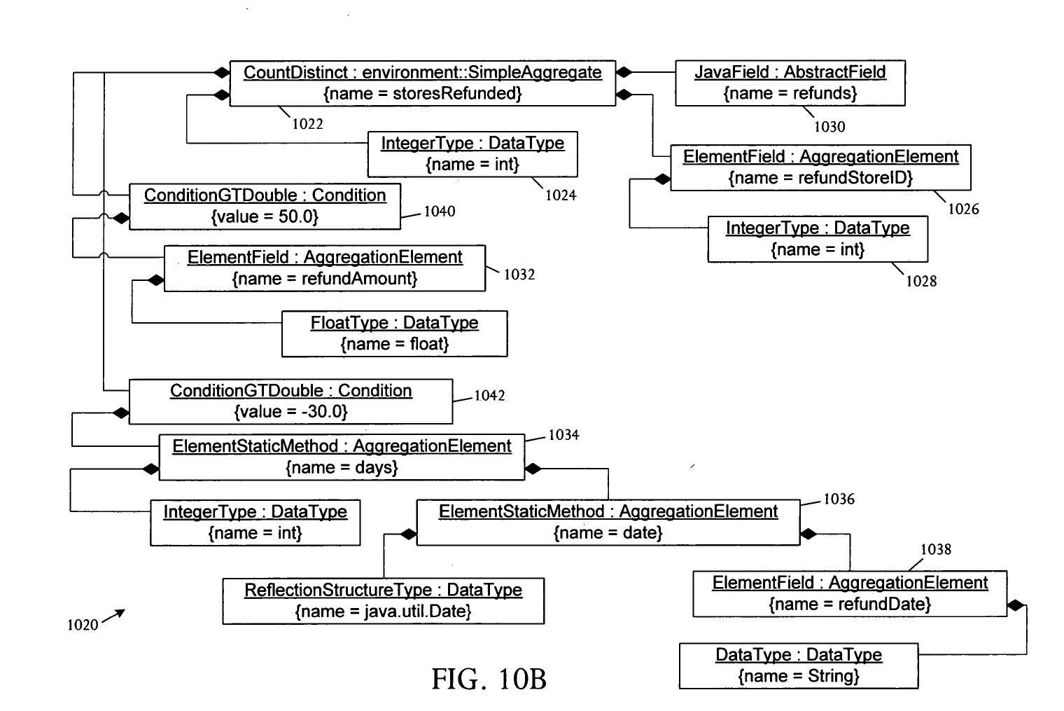

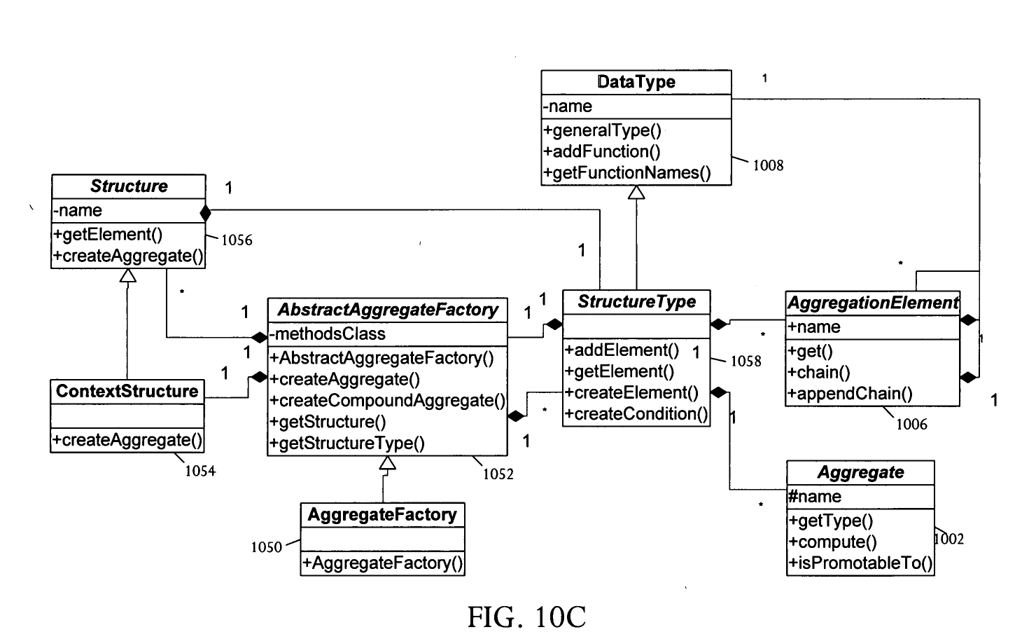

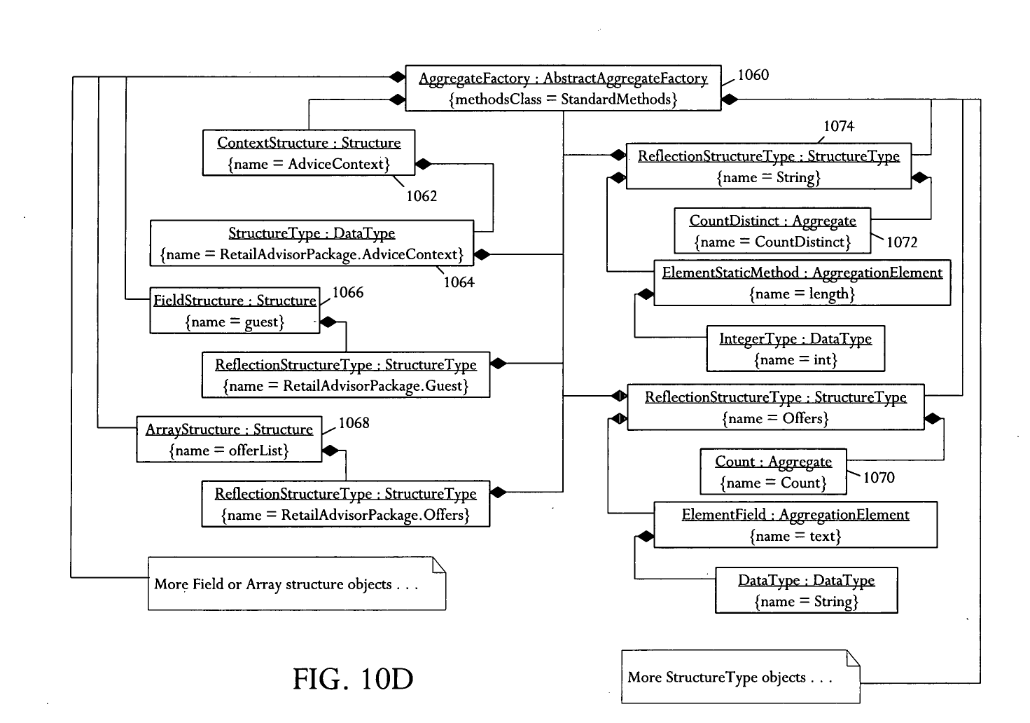

Referring to FIGS. 10A, 10B, 10C, and 10D, schematic Universal Modeling Language (UML) diagrams are shown that illustrate an embodiment of Aggregate and AbstractAggregateFactory class representations. FIG. 10A illustrates a SimpleAggregate and Compound Aggregate class diagram 1000. The Aggregate class 1002 has attributes including a name that is displayed in the window title by the Aggregate Wizard, and data type, representing the data type of the aggregated value. The data type can be any suitable type, such as IntegerType, DoubleType, LongType or another subclass of Data Type. SimpleAggregate 1010 and CompoundAggregate 1012 are subclasses of the Aggregate class 1002.

The SimpleAggregate class 1010 has attributes including an AbstractField member 1004, an AggregationElement member 1006, and zero or more Condition members 1014. The AbstractField member 1004 represents the structure, or array of structures, containing data to be aggregated. AbstractField member 1004 can represent the collection of database records, or a single record. The AggregationElement member 1006 represents an element in the structure that contains data to be aggregated. An AggregationElement 1006 can contain another AggregationElement 1006. The Condition members 1014 can be used to limit selection of rows from the collection of database records. A Condition contains one AggregationElement to which the Condition applies.

FIG. 10B depicts an example of a SimpleAggregate with conversions and conditions 1020. Referring to FIG. 10B in conjunction with FIGS. 9A through 9F, an example illustrates usage of the Aggregation Wizard in performing simple aggregation with conversions and conditions 1020. A SimpleAggregate object named “storesRefunded” 1022 is used by the Aggregation Wizard so that the Wizard window title area displays the name “Define Aggregate storesRefunded”. The DataType is the IntegerType subclass 1024. The element being aggregated (refundStoreID) 1026 is of the integer type 1028. The AbstractField 1030 is the JavaField subclass. In the example, the collection of database records is called “refunds”. The AggregationElement includes ElementField 1032 and ElementStaticMethod 1034 and 1036 subclasses. The SimpleAggregate element is called “refundStoreID”, and elements used in the Condition objects are called “days” 1034, “date” 1036, and “refundDate” 1038. The Condition is the ConditionGTDouble subclass. The first condition is “refundAmount>50.0” 1040, which selects only the database rows in which the refundAmount is greater than fifty dollars. The second Condition is “refundDate.date.days>−30” 1042, which selects only the database records for refunds occurring less than thirty days ago.

A CompoundAggregate object contains an array of Aggregate objects. The value of a CompoundAggregate is determined first by computing the value of the component Aggregation objects, then applying the compounding method, for example Ratio.

FIG. 10C depicts an AggregateFactory class diagram 1050. An AbstractObjectFactory object 1052 has attributes including a ContextStructure member 1054, zero or more Structure members 1056, and zero or more StructureType members 1058. The ContextStructure member 1054 defines and identifies the data that is passed to the recommender. The data can be defined as a CORBA structure in the CORBA IDL. The Structure members 1056 represent all of the different input objects available from the ContextStructure 1054. The Structure objects can be either standard Java objects, such as String, int or double, or can be user-defined types. The StructureType members 1058 represent the data type of objects in the input context for the recommender, and specify the standard aggregation functions available for the data type. The different data types are discovered at execution time using Java reflection.

FIG. 10D is a diagram that shows operation of the recommender in usage of the AggregateFactory 1060. The ContextStructure 1062 is referenced as “.”, which is of the StructureType 1064 RetailAdvisorPackage.AdviceContext. The context structure RetailAdvisorPackage.AdviceContext defines a “guest” object of type Guest 1066, and an “offerList” array of type “Offers” 1068. The StructureType 1064 named Offers is defined in the AdviceContext object and passed to the recommender. An Offer object from the Offers user-defined type contains a text field, specifying the Aggregation element of the object. Offer objects can be operated on by aggregation functions Count 1070 or CountDistinct 1072. The StructureType named String 1074 is a standard Java data type available from AdviceContext. The String structure type exposes standard methods, such as String.length( ), and user-defined methods, such as StaticMethods.Date(String) which can convert a String to a Date. A String can be operated on by Max, Min, Sum, and other standard aggregation functions.

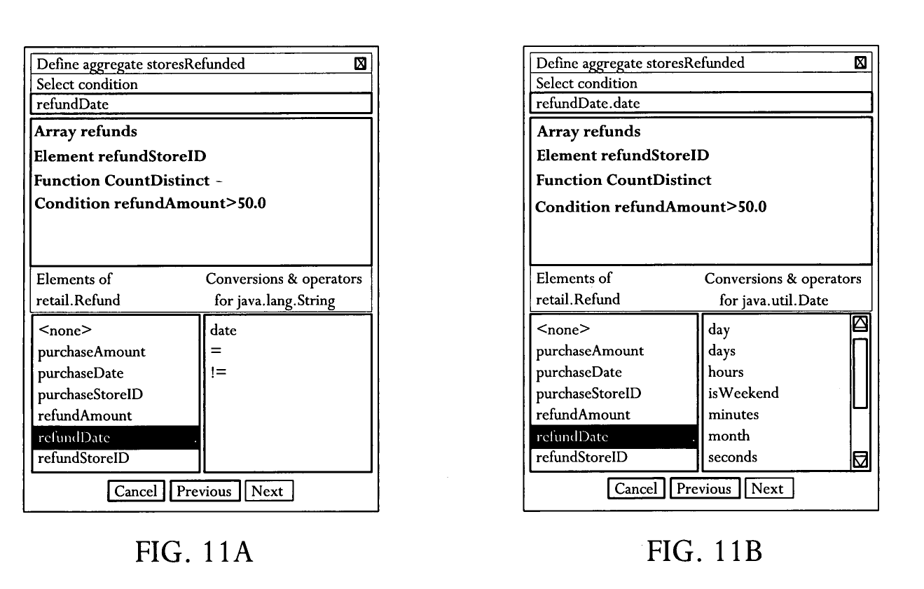

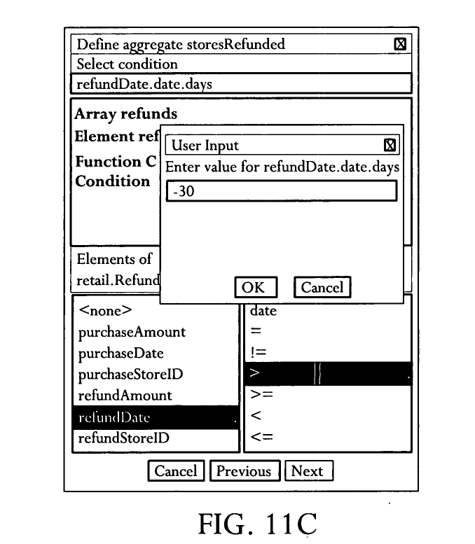

Referring to FIGS. 11A through 11C, pictorial views show display screens that can be generated in an example of an entry session and also depict handling of conversion methods. In FIG. 11A, Date is a method that converts a String to a Java Date, a useful method since dates are passed as strings in CORBA. FIG. 11B shows that a user can select from the elements of a Date or select any method taking a Date object. Referring to FIG. 11C, a user selects days, selects “>”, and enters “−30” to only include refunds in the last 30 days. Days returns the difference between a date element and today's date. A negative number indicates a past date. Date and days are examples of useful conversion methods supplied by the recommender. Conversion methods can be used in elements that are aggregated or in conditions.

FIGS. 11A through 11C illustrate that, in some embodiments, an information handling apparatus comprises an aggregation wizard that shows a first list and a second list. The first list alternatively lists items including: a first item type of static methods that can be written by an entity to compute a derived attribute of a record, and a second item type of a class that matches class of a static method parameter. The second list is operative for the second item type and lists static methods that can convert an attributes form.

Static methods can have different uses. For example, in one usage static methods can be written by a user to compute a derived attribute of a record. Such static methods are listed in the first list box when the parameter of the static method matches the class of the object selected in the first step of the wizard.

In a second usage, static methods can convert an attribute to another form, a conversion that can be a parse, an extraction, or a mathematical function, to name only a few possibilities. The second-type static methods are listed in the second list box when the item picked in the first list box is of the class that matches the class of the static method parameter. Furthermore, when the second conversion method is selected, the second list box is populated with a new set of conversions relevant to the data type returned by the most recent conversion method. The data type returned for a conversion can be a primitive Java™ data type or String, a standard Java™ class such as Date, or a customer-written class. Once a conversion to a class type is selected, the second list box displays not only applicable static methods, but also the public fields and “derived” fields exposed by get-methods of the class.

Some of the static methods displayed in the second list box are generally useful methods included with the recommender, including date and days methods. The user can implement a custom class containing static methods for both list boxes. The custom class has several properties. First, the custom class extends the StandardMethods class provided with the recommender. The custom class is named in a Java™ properties file that is read by the recommender. Also, the custom class is dynamically loaded by the aggregate wizard and aggregation engine.

The behaviors described for the two list boxes occur both in the second and fourth pages of the wizard. Derived attributes and conversions can be used both in the element to be aggregated and in the conditions that select eligible rows for the aggregation.

The user also has the option to create custom aggregate functions by writing one or more Java™ classes. The Java™ class name incorporates the function name and data type of the element. The super class of the custom aggregate function dereferences fields and methods, performs conversions, and selects applicable rows. The custom class can merely implement the aggregation logic on presented rows. The custom class also publishes the data type of the result which may differ from the data type of the element. The user may implement the custom aggregate function for as many different data types as desired.

On the first usage of the aggregate function, the user types the function name into the wizard. The wizard dynamically loads and verifies the user-written Java class for each known data type, and retains the function name in the list box whenever the function is applicable to the data type of the element being aggregated. The wizard presents for selection any aggregate function implemented for a larger compatible data type even if not implemented for the specific data type of the element.

In the illustrative manner, one who is not a programmer can define numerous simple aggregates quickly and easily. However, many aggregates fail to fit the simple model. In the illustrative system, all compound aggregates can be represented as compound aggregates composed of simple aggregates.

One example of a familiar compound aggregate is a ratio, a parameter common in sporting statistics. For example batting averages, earned run averages, and field goal percentages are all ratios. Another well-known business ratio is earnings per share (EPS), the ratio of a company's earnings to the number of outstanding shares. EPS is generally considered to be much more correlated to a company's stock price than either the numerator or denominator, and is thus a more valuable metric. Ratios are highly useful in data mining and can be used, for example in determining likelihood of success in offering a calling plan or detecting fraud. In data mining, useful ratios may include weekend calls to weekday calls, evening calls to daytime calls, long distance calls to local calls, calls to frequently called numbers as a percentage of total calls.

The recommender also comprises a compound aggregation wizard. The compound aggregation wizard includes a function selection page that enables a user to select a compound aggregate function from a list. The function determines component aggregate number and types. A component page enables the user to sequentially select at least one component aggregate from a list populated with all currently defined aggregates of an applicable type, and a compute method that computes the compound aggregate from the component aggregates.

The recommender can also supply a compound aggregate wizard to define composite aggregates. The first step of the wizard directs selection of a compound aggregate function from a list. The number and types of the component aggregates are determined by the particular function selected. Ratio is composed of two component aggregates, both of a numeric type. Accordingly, the second page of the compound aggregate wizard enables the user to select a first component aggregate from a list populated with currently defined aggregates of the applicable type. The user selects component aggregates consecutively. The wizard presents the finish button once the user selects the pertinent number of component aggregates. Some compound aggregates accommodate a variable number of component aggregates.

The ratio is a compound aggregate function that is likely to find wide use in data mining models. A user can also write custom compound aggregate functions. In an illustrative embodiment, each compound aggregate is implemented in a Java™ class. The compute method of the Java™ class computes the compound aggregates from the component aggregates. The Java™ class also implements methods that publish the appropriate number and data types of the component aggregates. The user can type the name of the custom compound aggregate class in a first step of the compound aggregate wizard and, once entered, the name remains listed in the first step of the wizard until changed.

A Genus Model Deployment Tool can be used to deploy data mining models into a Zero Latency Enterprise (ZLE) data store. Named aggregates used by the models are inserted into one table. A recommender configuration tool reads the table to determine which aggregates are as-yet undefined and awaiting user definition for implementation in deployed models. The recommender configuration tool stores defined aggregates in an aggregate store table. The recommender configuration tool displays a tabular screen showing currently-defined aggregates and aggregates-awaiting-definition. A previously-defined aggregate that no longer compiles, for example due to modification of the IDL, is highlighted, for example usage a red warning icon or light. The user launches the aggregate wizards from the recommender configuration tool to define a new aggregate or redefine existing aggregates.

During operation, the recommender servers are started and commence reading scoring models and aggregate definitions from tables in the database, in combination with other classes of metadata used by the recommender. The recommender uses reflection to construct aggregate objects that incorporate fields, static methods and aggregate functions, both standard and custom, in preparation for computing as requests arrive. In an illustrative embodiment, an aggregation engine can compute tens of thousands or more of aggregates per second.

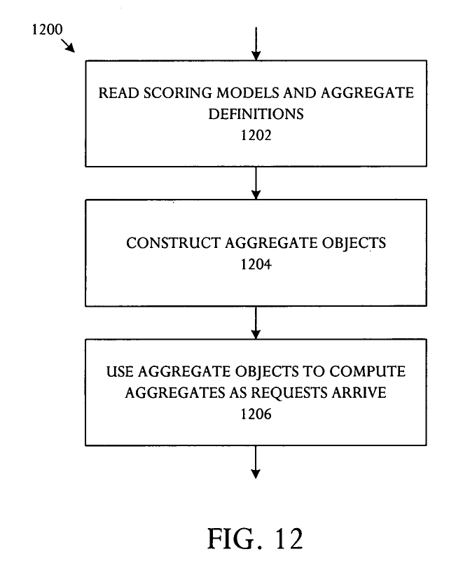

Referring to FIG. 12, a flow chart illustrates an embodiment of an information handling method 1200 for generating aggregate objects. The method comprises reading information 1202 including scoring models and aggregate definitions from database tables, and metadata. The method further comprises constructing aggregate objects 1204 incorporating the information including fields, static methods, and aggregate functions so that the aggregate objects are ready to compute as requests arrive 1206. Scoring model objects are also generated or constructed, and therefore made available for all ensuing interaction contexts. The objects are constructed from the Model Definitions, made available by the Genus Deployment Tool. A Scoring Model Object contains a compute( ) method which is invoked by the Recommender for an interaction that uses computation. A Scoring Model Object need only be constructed once and then can be used with the compute( ) method repeatedly many times, for example thousands of times or more, with future interactions that utilize the particular Scoring Model.

In some embodiments, the recommender can supply a harness that simulates the recommender environment within a Blaze Builder, a graphical tool used to write Blaze Advisor business rules. The harness enables the user to compile and test rules within Blaze Builder.

The recommender aggregation engine can enhance the capability to write and deploy business rules, even when real-time scoring is not used. Ordinarily, outside of the Hewlett Packard Company™ Zero Latency Enterprise (ZLE) architecture, business rules do not operate in combination with a scoring engine. Rules instead refer directly to computed or aggregated values in making decisions. For performance reasons, the aggregates are not normally computed within the Structure Rule Language from Blaze. Customers are advised to write a business object model (BOM) in Java™ and implement most computation inside the Java™ code.

In contrast, the illustrative recommender supplies a default business object model that includes facilities of recommender's aggregation engine. Use of the aggregation engine from business rules eliminates most of the need for custom methods in the business object model. However, as in many aspects of recommender operation, the user is enabled to create a custom business object model to extend recommender capabilities.

Blaze does supply limited built-in aggregation capabilities, including only simple count aggregates. One example of a Blaze quantified rule is as follows: If at least 3 item in the purchaseItems of context such that type is “wine” then offer (“cheese”). The illustrative recommender replaces the quantified rule with a non-quantified rule that uses a recommender aggregate. For example: If context.aggregateInt(“countWineItems”)>3 then offer (“cheese”). The countWineItems aggregate is defined using the aggregate wizard as a count function, on the purchaseItems structure, with the condition of type=“wine”. From the perspective of readability and maintainability, a user trades off considerations between defining aggregates within the rule and within the aggregate wizard. However, rule performance using the aggregation engine can be an order of magnitude better than the performance of the quantified rule. For other aggregates, for example sums and ratios that may be used in rules, viable alternatives to the recommender aggregation engine may be limited to hand-written Java™ methods applied to each individual aggregate in the business object model.

The recommender supplies an interface with a capability to reload and compile any combination of metadata categories on the fly, including aggregate definitions, deployed mining models, business rules, and offer definitions. Some reloads, notably rules recompilation, can be slow. To avoid service interruption, the recommender can implement a rolling reload utility.

In a particular recommender implementation, the CORBA object reference to the customized interface of the recommender can be a reference to a scalable server class. The reload request to the recommender can be defined in a non-customizable management interface. The CORBA object references provided for the management interface can be server instance references with server instance invoked individually for all management requests.

Java reflection can also be exploited in a test driver supplied for the recommender. Reflection enables a user to script both explicit and random test cases for the customized recommender interface without writing any custom Java™ code. The driver can be bound directly with server-side logic to enable standalone testing. The harness can also incorporate the driver, enabling a user to test business rules within Blaze Builder using the same test cases used for client-server or standalone testing.

The recommender enables real-time personalization and fraud detection in a ZLE environment using business intelligence tools.

The illustrative recommender is configured in modular form using components that can be used in various combinations. The modular architecture enables a user to deploy either business rules written with Blaze Advisor or data mining models created with SAS Enterprise Miner, or both in combination, within a ZLE system. The recommender also facilitates development and testing of rules and scoring models in various configurations, such as within Blaze Builder.

The aggregation engine is a common component for support of both a business rules engine and a scoring engine. The aggregation engine can be configured to facilitate easy and frequent redefinition of aggregates using the aggregate wizards.

The recommender can be customized to meet specific business criteria mainly by editing the IDL and entering metadata using graphical tools. The recommender can be further customized by writing Java™ classes generally by adding minimal user-written Java™ code in most circumstances.

In data mining, a score is a probability expressed as a floating-point value between 0 and 1. Typically the score represents the likelihood of a particular entity behavior or event outcome. For example, a user may wish to determine the likelihood a particular customer will respond favorably to a particular offer or the likelihood a certain event is fraudulent. In many cases, the likely outcome of several different courses of actions can be sought. Normally the user creates a separate mining model for each course of action. For example, a marketing company may have five different products that can be cross-sold and will probably create a separate mining model for each. Each mining model returns the probability of the customer accepting the corresponding offer.

The score is obtained by analyzing characteristics of the current customer that are similar to other customers that accepted the offer in the past. Data mining is the semi-automated process of finding those characteristics or combinations of characteristics that are strong predictors, both pro and con, for the behavior or outcome in question.

A population is associated with each score. The population is the customers or events in a sample that share relevant characteristics with the current customer or event. The larger the population, the more confidence is inherent in the statistical accuracy of the score.

In a specific illustration, a mining model can be built on a sample of 4,000 customers to whom were previously offered a “friends-and-family” plan. Some customers accepted the offer, some declined. A present consideration is whether to recommend the plan to Jane. For Jane, the scoring engine returns a score of 0.72 and population of 200. That means that 200 of the customers previously sampled were similar to Jane, by whatever characteristics are found to be relevant in the particular mining model, and out of the 200, 144 (72%) accepted.

Most characteristics used in mining models are aggregates—scalar values created from other available raw data. Derived attributes are also referenced as aggregates. Aggregates reduce a mass of data to a single value, usually a number. Examples of the common simple aggregate functions include counts, means, maxima, minima, sums, and count-distincts. For example, a count can be a total number of telephone calls. A mean can be the average length of a call. A maximum can be the most expensive phone call, the minimum a shortest phone call. The sum can be the total phone charges. A count-distinct can be the number of different phone numbers called.

Aggregates are generally more interesting when based on qualified cases. For example, a user can qualify phone calls to include in the aggregate by adding any of several conditions such as: occurring after 5:00 pm, during the last 30 days, on weekends, and/or longer than 10 minutes.

More compound aggregates can be created by combining several simple aggregates in a mathematical expression. A familiar compound aggregate is a ratio, composed of one simple aggregate divided by another simple aggregate. A telecommunications mining model might compile the ratio of weekend calls to total calls, a useful predictor for buying a weekend calling plan, or the ratio of distinct phone numbers called to the total number of phone calls, a useful predictor for joining a friends-and-family plan.

The aggregation engine can compute both simple and compound aggregates and includes the ratio compound aggregate. The aggregation engine enables creation of custom aggregate functions, both simple and compound, by writing very simple Java™ classes, and enables direct specification of simple conditions, or qualifiers, using the equal (=), less-than (<), or greater-than (>) symbols. More complex conditions can be implemented by writing a Boolean method in Java™.

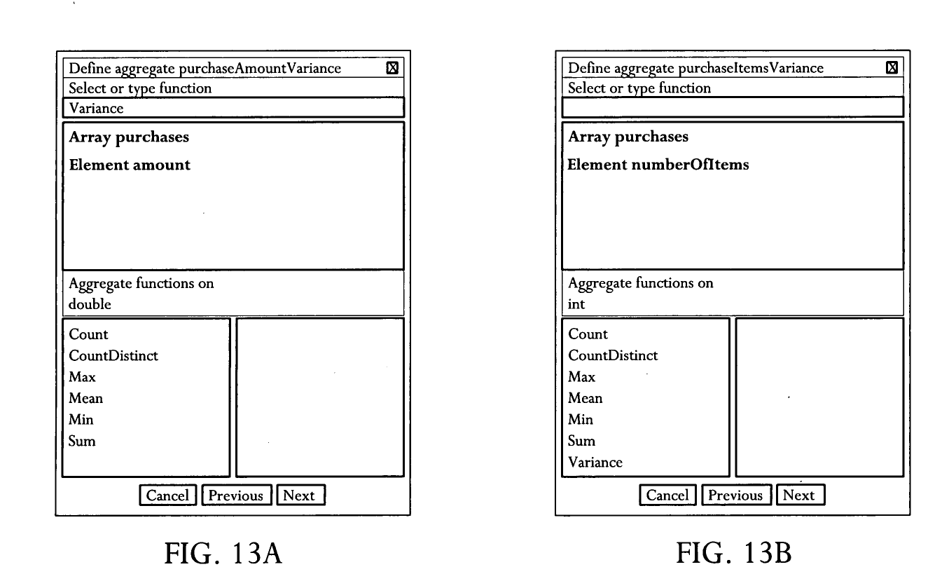

Referring to FIGS. 13A and 13B, two pictorial views show display screens that can be generated in an example of an entry session in an Aggregation Wizard embodiment that enables construction of custom functions. Referring to FIG. 13A, a user can enter user-created custom aggregate functions. FIG. 13B shows that the custom functions entered by a user are stored and displayed for all applicable data types.

Business rules can be written to request the score for the current customer or event from any mining model. The scores can be used in any way to decide which offers to make. However, the offer manager supplies a simple technique for mapping scores to offers. Using the recommender GUI tool, a user typically enters one row for each constructed mining model. Note that use of the same mining model in more than one row is allowed. The selected row identifies the offer associated with the model, and includes additional factors that help the offer manager to determine when the offer is to be extended.

Columns of the offer definition table can include Offer Group, Offer ID, Offer Text, Model Name, Threshold, Value, and Cost. Offer Group is a number that uniquely identifies a set of related offers & mining models. Offer ID is a number that uniquely identifies an offer within the group. Offer Text is displayable text of the offer. Model Name is the name of the associated mining model. Threshold is a floating point number that determines whether the offer can be extended. Value is a floating point number that represents the value of a positive outcome. Cost is a floating point number representing the cost of a negative outcome.

The offer manager only analyzes the offers for one offer group at a time and attempts the mining model for every offer in the group. From the score for each mining model, the offer manager computes a weighted score based upon the value and cost factors, as follows:
WeightedScore=(likelihood*value)−((1−likelihood)*cost).

If value is specified as the net monetary value of an offer that is accepted, and cost is the net monetary cost of an offer that is declined, the WeightedScore is equal to the predicted average profit from each offer extended. Alternatively, the terms need not be interpreted monetarily.

The offer manager can skip any offer having a weighted score less than the threshold. The user specifies the maximum number of offers that the offer manager returns. If only one offer is allowed, the offer manager generally is configured to always choose the offer in the relevant offer group that has the highest valuation. If multiple offers are allowed, the offer manager may return the offers in descending order of valuation. If all offers have a cost of 0 and value of 1, the respective defaults. Valuation is the same as likelihood. Only setting of a very low threshold results in a guarantee that any offer is returned.

A particular application may use additional specialized information along with each offer. For example, a user may wish to add a URL pointing to a web page for the offer. A user can add more columns to the table of offer definitions. The recommender GUI tool automatically exposes the additional columns for editing.

A user may create separate offer groups for different purposes, such as detecting fraud, and making a cross-sell. The different groups can be used in different situations, such as for different interaction types or different regions or countries. A user can define multiple groups in the same situation, resulting in an expectation to receive multiple returned offers.

The user can decide which offer group is relevant at any time based on the business rules, and call the offer manager with the appropriate parameters. If not using Blaze, the user can specify the offer groups relevant to the recommender through an entry in the properties file. If the recommender uses different offer groups in different situations and Blaze is not used, the user can write a simple custom Java™ class that distinguishes relevant circumstances and calls the offer manager with the appropriate offer group.

Users of the ZLE Development Kit (ZDK) customize the recommender interface according to the users' business data model by editing the starter CORBA Interface Definition Language (IDL) file supplied by the ZDK. The customized interface enables the recommender to receive any number of pre-defined record sets obtained from NonStop SQL by the interaction manager. The record-sets usually represent previous customer interactions and/or customer data objects.

After customization of the IDL, the user runs the IDL compiler (idl2java) to generate CORBA stubs and skeletons. The resulting Java™ files are java-compiled (javac) to generate class files. In most cases, the customized recommender can be tested and deployed after manually writing very little, if any, Java™ code. Instead, graphical tools are used to define the offers, business rules, data elements and aggregates, and the like, that constitute the business logic of the recommender.

Various recommender components use Java™ properties as the basis for identifying customized elements, including classes and methods, of the interface. The properties are obtained from a text file edited by the developer of the customized recommender. Then the components introspect on the Java stubs and skeletons to obtain the additional information for operation. The recommender uses Java Reflection APIs to perform introspection.

The recommender IDL includes a method that returns one or more offers, advices or recommendations. The method may be given any name. The name is identified by the property InvokeMethod.

The method takes one input parameter of a type that corresponds to a struct defined in the IDL. The struct is called the “context struct” and contains the contextual information used to produce the recommendations. The struct can be also be given any name and the IDL compiler generates a Java class with the same name. The name of the class is identified to the recommender by the property ContextClass. The “context class” is passed between the recommender driver and the recommender and has a makeup entirely defined by the user in a “struct” statement of the IDL.

Offers returned by the recommender are instances of another customized class defined in the IDL file as a struct. The name of the class is identified by the property OfferClass. The InvokeMethod returns an array of these offers.

The context class can be customized. Any number of predefined record-sets obtained from NonStop SQL can be passed in the context class. The columns of each such record-set are defined by another struct in the IDL file. The record-set is declared as a sequence of the struct. The context struct contains a named reference to the sequence. In Java™, the context class contains an array of references to instances of the class defined by the struct.

A single record can be passed in the context class. Columns of the record are defined by another struct in the IDL file. The context struct contains a named reference to the struct. In Java™, the context class contains a reference to an instance of the class defined by the struct.

The distinction between a record-set, the reference to a sequence of struct, and a single record, the direct reference to a struct, is of fundamental importance to the recommender. The recommender performs aggregate functions such as min, max, mean, sum, count and count-distinct, on record-sets. The recommender also allows conditions to be specified in the aggregate definition for any record-set, which selects the applicable records, or rows, to be included in the aggregate function. Neither the aggregate function nor the condition applies in the case of a single record. Any aggregate that refers to a single record directly returns either the value of some field in the record, or a value computed from several fields in the record.

Whether passing a single record or a record-set, the same rules apply to the contents of the component struct. Fields of the struct can be defined to be of any of the built-in types common to CORBA IDL and Java:

| IDL | Java | Comment |
|---|---|---|
| octet | byte | 8-bit signed integer |
| short | short | 16-bit signed integer |
| long | int | 32-bit signed integer |
| long long | long | 64-bit signed integer |
| float | float | 32-bit floating point |
| double | double | 64-bit floating point |
| string | java lang.String | variable length string of |
| | | characters |
| char | char | a single character |
| boolean | boolean | a byte representing true or |
| | | false |

Each column of the record-set that is passed is declared in the IDL as one of the listed types. Any field of the listed datatypes is designated as elementary fields.

Offer classes can be customized. The struct in the IDL that defines the offer class initially contains six fields that are expected by the offer manager and/or the starter Blaze Advisor business rule base. The fields are:

| IDL | Comment |
|---|---|
| long offerGroup | A group identifier for the offer |
| long offerId | A numeric identifier for the offer within the |
| | group |
| string offerText | Displayable text of the offer |
| float score | Probability that the offer will be accepted |
| long population | Number of past cases that the probability is |
| | based upon |
| float weightedScore | Score weighted by the value and/or cost |
| | placed on the offer |

The likelihood and population come from the scoring engine.

The offer manager computes weightedScore from the score and factors in the offer definition table.

More fields can be added to the offer class including fields of any of the built-in types common to CORBA and Java.

The following is an example of recommender IDL for a telecommunications application:

```
struct Customer {
    long long accountNumber;
    string name;
    string billingAddressLin23;
    string billingAddressLine2;
    string billingCity;
    string billingState;
    long billingZipCode;
};
struct CallDetailRecord {
    long long callingNumber;
    long long calledNumber;
    string timeOfCall;
    long lengthOfCall;
    double charge;
};
typedef sequence<CallDetailRecord> CDRs;
struct PhoneLine {
    long long number;
    short serviceType;
    boolean fixedLine;
};
typedef sequence<PhoneLine> PhoneLines;
struct Offer {
    long offerGroup;
    long offerId;
    string offerText;
    float score;
    long population;
    float weightedScore;
};
typedef sequence<Offer> Offers;
struct CallerContext {
    Customer customer;
    CDRs cdrs
    PhoneLines phoneLines;
    string callingNumber;
};
Offers recommend(in CallerContext callerContext);
```

And some relevant properties of file entries are shown for this example:

InvokeMethod=recommend
ContextClass=CallerContext
OfferClass=Offer

The context class (CallerContext) includes one singular record (customer), two sequences of records (cdrs and phoneLines), plus one elementary field (callingNumber). The offer class (Offer) contains only the standard elements of offer classes.

The Recommender Graphical User Interface (GUI) defines aggregates and offers. The aggregates and offers are stored in Operational Datastore (ODS) as metadata, and are used by the recommender engine to make recommendations.

A user executes the recommender GUI program with the following command-line argument: <Properties-file> in which the argument is the name of a Java™ properties file that defines the ContextClass, MethodsClass, and the JDBC parameters used by the GUI.

Upon launching the Recommender GUI, the Recommender GUI displays available aggregates, reads the AGGREGATE table to load predefined aggregates, and reads the MODVARS table to load the aggregates used by data mining models.

For simple aggregates the structure, element, function and zero or more conditions are displayed. For compound aggregates, the compound aggregate function is displayed in the function column, and one or more aggregate names are displayed in the condition column.

For an existing aggregate that is not completed, the aggregate name is displayed in highlights. For an existing aggregate that fails to compile, the aggregate name is displayed in another highlighted color or form.

To add an aggregate, a user clicks on the “Add” button, fills in the aggregate name, and selects the “Compound?” check box if an compound aggregate is added. The Aggregate Wizard or the CompoundAggregate Wizard launches.

To redefine an aggregate, the user click-selects the aggregate and presses the right mouse button. From the popup menu, the user selects “Define Aggregate” or “Define Compound Aggregate”. The Aggregate Wizard or the Compound Aggregate Wizard launches with the previous values displayed. If a simple aggregate is redefined as a compound aggregate, or the converse, no previous values are displayed.

A user deletes an aggregate by click-selection, then clicking on a “Delete” button, deleting the aggregate from the AGGREGATE table.

The aggregate wizard executes on addition or redefinition of a simple aggregate. The wizard contains four pages that define the aggregate structure, element, function and condition. Each page contains a “Cancel” button to cancel at any time, a “Next” button to advance to the next page, and a “Previous” button to return to the previous page. Each user selection is displayed in a status area in the middle of the wizard.

The structure page displays a list of structures available from the context class. The user selects a structure and presses “Next” button.

The element page displays a list of elements available from selected structure. The user selects an element. A list of conversions, defined in MethodsClass, may be displayed for the element. A conversion selected by the user is appended to the element. A new list of conversions may be displayed for the new element. To remove the conversions and start over, the user simply selects another element. If the element is part of a flat structure, then the user presses “Finish” button to save the aggregate. Otherwise the user presses “Next” button.

If the user redefines an aggregate used by data mining models, the element, and any conversions, type is checked against the type used by the models. The models use numeric or string aggregate types. If the user-defined type does not match, the user receives a warning.

The function page displays a list of aggregate functions applicable to the selected element. The user selects a function from the list, or types the name of a custom aggregate function. The function is validated when the user presses “Next” button. If the custom aggregate function fails validation, the user makes another selection.

The condition page displays a list of elements available from selected structure. If the user does not intend to define a condition, then the user presses “Finish” button to save the aggregate. Otherwise, the user selects an element. If the element is a boolean, then the user can save the condition. A list of applicable operators is displayed for the element and a list of conversions, defined in MethodsClass, may be displayed for that element. To create a condition, the user selects an operator, then enters a value when prompted. The values entered by user are validated, and the condition is not saved if the validation fails. For example, no blank spaces are allowed in the input, and numeric values cannot have alphabetic characters.

To save the condition, the user presses “Next” button. The user can define multiple conditions, by repeating the steps. To remove a condition, the user presses the “Previous” button. After the last condition, the user presses “Finish” button to save the aggregate.

Compound Aggregate Wizard executes the user adds or redefines a compound aggregate. The wizard contains two pages that define the compound aggregate function and the list of applicable aggregates. Each page contains “Cancel” button to cancel at any time, a “Next” button to advance to the next page, and a “Previous” button to return to the previous page. Each user selection is displayed in a status area in the middle of the wizard.

The function page displays a list of compound methods available from the classpath. The compound methods are defined as classes in the aggregation package, and subclasses in the CompoundAggregate class. The user selects a function from the list, or types the name of a custom aggregate function. The function is validated when the user presses “Next” button. If the custom aggregate function fails validation, the user makes another selection.

The aggregates page displays a list of available aggregates that can be used with the compound function. The user selects an aggregate and presses the “Next” button. Then the aggregates page is repeated as many times as appropriate for the aggregate function. For example, the Ratio aggregate function has two aggregates, therefore the aggregates page is displayed two times. Then the “Finish” button is displayed. When the user presses the “Finish” button the compound aggregate is saved.

The “Next” button is not enabled until the user makes a selection. The “Finish” button is enabled as soon as the user selects the minimum number of aggregates or when the user selects the maximum number of aggregates.

The recommender is a black-box application with a source code that is not typically modified by a user. However, a user can add custom classes that are called by the framework, according to application and operating criteria. The custom classes normally implement an interface through which the classes are used by the recommender. The process for adding custom classes to the recommender involves creation of custom Java™ classes, compilation and archiving of Java™ classes, modification of property files and metadata, and importing of Java™ classes into the Blaze Advisor.

The recommender enables writing of classes that extend capabilities of the recommender in several ways. The user-written classes are typically identified to the recommender through entries in the properties fie or through metadata entered into the data store using the recommender GUI. The recommender loads the user-written classes dynamically using Java™ reflection APIs.

The recommender supplies two classes that can be used to deploy a recommender CORBA server. RulesServer calls the Blaze Advisor rules engine to select offers. OfferServer calls the offer manager to select offers. The user identifies the type of recommender server to deploy by specifying the name of the class when launching the Java™ Virtual Machine (JVM). The user may wish to build a recommender that is more specialized. For example, the user may desire a recommender with a capability to selectively call the offer manager or rules engine based on different interaction types or other variables in the context. The custom server can also process reload requests for additional types of metadata.

Also, a user can implement a custom tester or driver by creating a class that extends ContextTester or StandardDriver. ContextTester implements the recommender testing language. StandardDriver extends ContextTester and additionally implements the management interface including reload, statistics, and trace commands.

A customized tester or driver may implement additional mode commands by extending the mode class. The custom Mode class is incorporated into the recommender by setting the ContextTester field called mode to refer to the custom mode class that the user constructs in the customized tester or driver.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, components, and dimensions can be varied to achieve the desired structure as well as modifications, which are within the scope of the claims. Variations and modifications of the embodiments disclosed herein may also be made while remaining within the scope of the following claims. For example, the described example of a recommender wizard operation relates to sequentially guiding a user through operations with subsequent, relevant dialog boxes. Other selection metaphors may be used, such as a single dialog box which allows a user to make all selections at once, perhaps by the use of tabs or different sections of a dialox box, that is, not sequentially. The term “offer” as described herein is a general reference that relates to a broad range of events, actions, and phenomena including, for example, a prediction of fraud, a recommended advice, or the like. Also, the specific embodiments described herein identify various computing languages, application software packages, and systems that operate as part of or in conjunction with the illustrative information handling system, components, and methods. In other embodiments, any suitable languages, applications, systems, and operating methods may be used. The various embodiments described herein have multiple aspects and components. These aspects and components may be implemented individually or in combination in various embodiments and applications. Accordingly, each claim is to be considered individually and not to include aspects or limitations that are outside the wording of the claim.

1. A recommender for usage in a data mining system comprising:
a scoring engine capable of scoring information using at least one data mining model that derives scores from aggregated data;
an offer manager capable of mapping scores to offers based on entered configuration information;
an aggregation engine that computes user-defined aggregates dynamically for real-time scoring by the scoring engine;
a user interface that exposes entity data through a user-written Interface Device Language (IDL), the IDL defining a context object containing the input data including record-sets, singular records, and scalar elements; and
at least one aggregate wizard that defines aggregates and reflects on the user interface.

2. The recommender according to claim 1 wherein:
the aggregation engine is capable of computing aggregates in real-time from in-memory data that is dynamically cached during a session with an entity.

3. The recommender according to claim 2 further comprising:
an aggregation wizard that enables a user to select a record collection in the in-memory data, select an element of the record collection as a value to be aggregated, select an aggregate function, select a condition to apply, and aggregate by applying the selected condition.

4. The recommender according to claim 3 further comprising:
an aggregation wizard that enables a user to select an element upon which the condition is based, select an operator, and select a value for comparison.

5. The recommender according to claim 3 further comprising:
an aggregation wizard that enables a user to write a custom static method to compute derived attributes.

6. An information handling method comprising:
constructing aggregates for a case set;
computing aggregates from detailed in-memory data that is dynamically cached; and
iteratively mining data during an entity transaction to define new aggregates and refine existing aggregates based on entity responses, the aggregates being defined and refined using a wizard.

7. The method according to claim 6 further comprising:
performing aggregation for real-time scoring.

8. The method according to claim 6 further comprising:
drawing aggregates from different tables in a memory containing entity-related data.

9. The method according to claim 6 further comprising:
computing a compound aggregate from at least one other aggregate.

10. A real-time information handling apparatus comprising:
an interaction manager that populates a recommender context with data cached for an entity transaction session;
a recommender that receives the recommender context, the recommender further comprising:
at least one recommender driver and/or utility;
a custom recommender server that is configured via the at least one recommender driver and/or utility dynamically loading a stub; and
an aggregation engine defined using a graphical user interface wizard that reflects upon Java classes generated from the graphical user interface to identify available records and attributes.

11. The apparatus according to claim 10 wherein the recommender further comprises:
a scoring engine capable of computing scores for at least one predefined business model and to make offers contingent on resulting scores.

12. The apparatus according to claim 10 wherein the recommender further comprises:
an offer manager capable of using criteria entered into a table to select offers based on scores from at least one data mining model.

13. The apparatus according to claim 10 wherein the recommender further comprises:
an interface capable of reloading and compiling a combination of metadata categories in real-time including aggregate definition models, deployed data mining models, business rules, and offer definitions.

14. The apparatus according to claim 10 wherein:
the recommender context comprises stubs and skeletons, and structures and/or record-sets, a distinct class being generated for each structure or record set, the class representing the recommender context.

15. An information handling method comprising:
populating a recommender context with data cached for an entity transaction session;
compiling a customized interface definition language file to generate stubs and skeletons;
generating a distinct class for each structure or record-set including each record-set as an array of objects;
dynamically loading a skeleton to create a custom server;
defining aggregates using a wizard that reflects upon classes generated from an interface to identify available records and attributes; and
computing aggregates from data cached in memory.

16. An information handling method comprising:
creating simple aggregates using a simple aggregate wizard comprising:
selecting a record-set to be aggregated from a list populated with all objects in a context class;
selecting an element for aggregation from a list populated with fields of an object of the context class objects; and
selecting an aggregation function from a list populated with known aggregate functions applicable to a data-type of a field of the object fields.

17. The method according to claim 16 further comprising:
selecting zero or more conditions for the aggregate, a condition capable of being autonomously selected based on the element selection.

18. The method according to claim 16 wherein:
the aggregation functions include at least one function selected from among a group consisting of count, sum, min, max, mean, count-distinct, and, or, first, and last, the functions including arithmetic functions and Boolean functions.

19. The method according to claim 16 further comprising:
defining a context to include a struct to designate a unique record or a record containing pre-computed historical aggregates.

20. The method according to claim 16 further comprising:
aggregating an element that is a column of a record in a first case; and
aggregating an element by deriving an attribute from operations on a plurality of at least one column of the record in a second case.

21. An information handling apparatus comprising:
an aggregation wizard further comprising:
a first list populated by elements of structure and by a derived method that takes class of the structure as a parameter, the first list alternatively listing items including: a first item type of static methods that can be written by an entity to compute a derived attribute of a record, and a second item type of a class that matches class of a static method parameter; and
a second list populated by types of elements, the second list being operative for the second item type and capable of listing static methods capable of attribute form conversions.

22. The apparatus according to claim 21 wherein:
attribute form conversions are selected from among a group comprising a parse, an extraction, a mathematic operation, and a Boolean operation.

23. The apparatus according to claim 21 wherein:
for the second item type, the second list is populated upon selection of a conversion method with a new set of conversions relevant to a data type returned by the most recent conversion method selected, the data types being selected from among a group comprising a primitive data type, a string, a standard class, or an entity-written class.

24. The apparatus according to claim 23 wherein:
for conversion to a class type, the second list displays applicable static methods, public fields, and derived fields.

25. The apparatus according to claim 21 further comprising:
a relational operator static method for which the aggregation wizard:
parses a string parameter and returns an object of a relational operator class;
operative when the second list includes a relational operator, displaying fields and get-methods of the relational operator class; and
extracting a corresponding value for comparing against the relational operator.

26. The apparatus according to claim 25 further comprising:
a relative element static method for which the aggregation wizard:
receives a relational element parameter and returns a number relative to an origin, designated as positive and negative relative to the origin.

27. The apparatus according to claim 21 wherein:
the function page enables the user can enter a name of a custom aggregate.

28. The apparatus according to claim 21 wherein:
the aggregation wizard dynamically loads and verifies a user-written class for each known data type.

29. An information handling apparatus comprising:
a compound aggregation wizard further comprising:
a function selection page that enables a user to select a compound aggregate function from a list, the function determining component aggregate number and types;
a component page that enables the user to sequentially select at least one component aggregate from a list populated with all currently defined aggregates of an applicable type; and
a compute method that computes the compound aggregate from the component aggregates.

30. The apparatus according to claim 29 wherein:
the component page displays a finish button that enables a user to complete selection of the component aggregates, the number of component aggregates for a particular compound aggregate being fixed for some aggregates and variable for some aggregates.

31. The apparatus according to claim 29 wherein:
the function page enables the user to define a name of a custom compound aggregate class.

32. The apparatus according to claim 29 wherein:
the compound aggregation wizard dereferences fields and methods, performs conversions, and selects applicable rows of a data array.

33. An article of manufacture comprising:
a controller usable medium having a computable readable program code embodied therein for mining data, the computable readable program code further comprising:
a code capable of causing the controller to populate a recommender context with data cached for an entity transaction session;
a code capable of causing the controller to compile a customized interface definition language file to generate stubs and skeletons;
a code capable of causing the controller to generate a distinct class for each structure or record-set including each record-set as an array of objects;
a code capable of causing the controller to dynamically load a skeleton to create a custom server; and
a code capable of causing the controller to define aggregates using a wizard that reflects upon classes generated from an interface to identify available records and attributes.

34. An article of manufacture comprising:
a controller usable medium having a computable readable program code embodied therein for mining data, the computable readable program code further comprising:
a code capable of causing the controller to create simple aggregates using a simple aggregate wizard comprising:
a code capable of causing the controller to select a record-set to be aggregated from a list populated with all objects in a context class;
a code capable of causing the controller to select an element for aggregation from a list populated with fields of an object of the context class objects; and
a code capable of causing the controller to select an aggregation function from a list populated with known aggregate functions applicable to a data-type of a field of the object fields.
